(19) United States
(12) Patent Application Publication
(10) Pub. No.: US 2007/0279327 A1
(43) Pub. Date: Dec. 6, 2007

(54) Display device and its driving method

(76) Inventors: Sang-Hoon Yim, Suwon-si (KR); Hak-Cheol Yang, Suwon-si (KR)

Correspondence Address: Robert E. Bushnell, Suite 300, 1522 K Street, N.W., Washington, DC, 20005, US

(21) Appl. No.: 11/783,555

(22) Filed: Apr. 10, 2007

(30) Foreign Application Priority Data
Jun. 1, 2006 (KR) 10-2006-0049544

(51) Int. Cl. G09G 3/28

(52) U.S. Cl. 345/60

(57) ABSTRACT

A display device has centers of three sub-pixels arranged to form a triangle together and one side of the triangle is orientated in the same direction as a vertical direction of a displayed image. When a black or white vertical line is displayed, image signal data of left and right pixels adjacent to the black or white vertical line are converted into cyan-biased or magenta-biased image signal data, thereby enhancing the visibility and readability of displayed characters.

### CLAIM OF PRIORITY

This application makes reference to, incorporates the same herein, and claims all benefits accruing under 35 U.S.C. §119 from an application for DISPLAY DEVICE AND DRIVING METHOD THEREOF earlier filed in the Korean Intellectual Property Office on the 1 Jun. 2006 and there duly assigned Serial No. 10-2006-0049544.

### BACKGROUND OF THE INVENTION

1. Field of the Invention

The present invention relates to a display device and its driving method, and more particularly, to a method of driving a plasma display device including a Plasma Display Panel (PDP).

2. Description of the Related Art

A plasma display device is a display device using a PDP that displays characters and images by using a plasma generated by a gas discharge.

The PDP can implement a vary large screen of more than 60 inches with a thickness of 10 cm or less, and does not produce distortion with respect to color representation and viewing angle, similar to a self-emission display device, such as a CRT.

The PDP includes a three-electrode surface-discharge PDP. The three-electrode surface-discharge PDP includes a substrate having sustain electrodes and scan electrodes positioned on the same plane, and another substrate separated by a gap from the substrate and including address electrodes formed in a vertical direction. A discharge gas is encapsulated between the substrates.

In the PDP, discharging is determined by a discharge of the scan electrodes and the address electrodes that are connected to each line and independently controlled, and a sustain discharge for displaying an image occurs by the sustain electrodes and the scan electrodes positioned on the same plane.

FIGS. 1 and 2 are plan views of arrangements of pixels and electrodes of the PDP according to the related art. FIG. 1 illustrates a PDP having a stripe type of barrier rib structure and FIG. 2 illustrates a PDP having a delta type of barrier rib structure.

As shown in FIG. 1, in the PDP having the stripe type of barrier rib structure, discharge cells are formed between the sustain electrodes (Xi˜Xi+3) and the scan electrodes (Yi˜Yi+3) that face each other, while forming a discharge gap therebetween.

One pixel 61 includes adjacent red, green, and blue discharge cells 61R, 61G, and 61B, namely, three sub-pixels, among discharge cells. The address electrodes are formed to pass through the discharge cells 61R, 61G, and 61B constituting the single pixel 61, respectively.

Accordingly, as shown in FIG. 1, in the case of 16 pixels 61, a total of 12 address electrodes 65 Aj˜Aj+11 are required, namely, three address electrodes for each pixel. In this respect, as the PDP is developed to have high resolution, the discharge cells are highly integrated so the address electrodes 65 passing through the discharge cells become closer to each other, increasing capacitance (C) between adjacent address electrodes, which inevitably increases energy (=CV²f) consumption.

With reference to FIG. 2, in the PDP having the delta type of barrier rib structure, the discharge cells are partitioned into independent spaces by barrier ribs, and a single pixel 71 includes red, green, and blue discharge cells 71R, 71G, and 71B disposed adjacent to each other and that form a triangle, among the discharge cells. The address electrodes 75 are formed to pass through the discharge cells 71R, 71G, and 71B that constitute the single pixel 71, respectively.

In this case, for sixteen pixels 71, a total of twelve address electrodes Aj˜Aj+11 are required, namely, three address electrodes for each pixel 71. In this respect, as the PDP is developed to have high resolution, the discharge cells are highly integrated so the address electrodes 75 passing through the discharge cells become closer to each other, increasing capacitance (C) between adjacent address electrodes, which inevitably increases energy (=CV²f) consumption.

### SUMMARY OF THE INVENTION

The present invention has been made in an effort to provide a Plasma Display Panel (PDP) having a reduced the number of address electrodes corresponding to each pixel by enhancing a pixel arrangement.

The present invention has been also made in an effort to provide a method of driving a plasma display device in which good images are implemented by the plasma display device including a PDP with a smaller number of address electrodes.

An exemplary embodiment of the present invention provides a method of driving a display device in which a plurality of pixels each having three sub-pixels are formed, centers of the three sub-pixels define a triangle together, and one side of the triangle is in the same direction as a vertical direction of a displayed image. The method for driving a display device includes: when a black vertical line or a white vertical line having at least one pixel is displayed, converting image signal data of a first pixel, the left pixel adjacent to the black vertical line or the white vertical line, into image signal data with a bias of cyan or magenta (namely, into cyan-biased or magenta-biased image signal data); and when the black vertical line or the white vertical line is displayed, converting image signal data of a second pixel, the right pixel adjacent to the black vertical line or the white vertical line, into cyan-biased or magenta-biased image signal data; and displaying the converted image signal data on the display device.

The converting of the image signal data of the first pixel may include, if the first pixel refers to a plurality of pixels, converting the image signal data of the first pixel such that the cyan-biased image signal data and the magenta-biased image signal data are alternately arranged.

The converting of the image signal data of the second pixel may include, if the second pixel refers to a plurality of pixels, converting the image signal data of the second pixel such that the cyan-biased image signal data and the magenta-biased image signal data are alternately arranged.

The converting of the image signal data of the first pixel may include converting the image signal data of the first pixel by reflecting image signal data of adjacent left and right pixels of the first pixel on the image signal data of the first pixel, and the converting of the image signal data of the second pixel may include converting the image signal data of the second pixel by reflecting image signal data of adjacent left and right pixels of the second pixel on the image signal data of the second pixel.

The display device may further include a plurality of row electrodes and a plurality of column electrodes defining each sub-pixel, wherein two of the three sub-pixels may correspond to the same column electrode, and each pixel may correspond to a 3/2 number of row electrodes.

Another embodiment of the present invention provides a method of driving a display device in which a plurality of pixels, each having three sub-pixels, are formed, centers of the three sub-pixels defining a triangle together, and one side of the triangle is in the same direction as a vertical direction of a displayed image. The driving method includes: converting image signal data of each pixel by reflecting image signal data of adjacent left and right pixels of each pixel; calculating a first dispersion among sub-pixels of each pixel; calculating a second dispersion among sub-pixels by using the converted image signal data; and when the second dispersion is equal to or smaller than the first dispersion in the same pixel, converting image signal data of a corresponding pixel into the original image signal data. The dispersion among the sub-pixels can be calculated using the image signal data of the three sub-pixels. When the black vertical line or white vertical line having at least one pixel is displayed in the same direction as the vertical direction, the left and right pixels adjacent to the black vertical line or the white vertical line can be converted into the cyan-biased or magenta-biased image signal data by converting the image signals of each pixel.

Yet another embodiment of the present invention provides a display device. The display device includes: a display panel having a plurality of row electrodes, a plurality of column electrodes formed to cross the plurality of row electrodes, and a plurality of pixels defined by the plurality of row electrodes and the plurality of column electrodes, each pixel including three sub-pixels whose centers define a triangle together with one side of the triangle being in a first direction in which the column electrodes extend; a controller to generate a control signal for driving the plurality of row electrodes and the plurality of column electrodes from inputted image signal data; and a driver to drive the plurality of row electrodes and the plurality of column electrodes according to the control signal, wherein when a black vertical line having at least one pixel and being in the same direction as the first direction is displayed, the controller converts image signal data of left and right pixels adjacent to the black vertical line into cyan-biased or magenta-biased image signal data.

The controller may convert the image signal data of the left pixel such that the cyan-biased image signal data and the magenta-biased image signal data can be alternately arranged at the left pixel adjacent to the black vertical line, and may convert the image signal data of the right pixel such that the magenta-biased image signal data and the cyan-biased image signal data can be alternately arranged at the right pixel adjacent to the black vertical line.

When a white vertical line having at least one pixel and being in the same direction as the first direction is displayed, the controller may convert the image signal data of the left and right pixels adjacent to the white vertical line into cyan-biased or magenta-biased image signal data. The controller may convert the image signal data of the left pixel such that the magenta-biased image signal data and the cyan-biased image signal data can be alternately arranged at the left pixel adjacent to the white vertical line, and may convert the image signal data of the right pixel such that the cyan-biased image signal data and the magenta-biased image signal data can be alternately arranged at the right pixel adjacent to the white vertical line.

The controller may include a rendering processor to convert image signal data of each pixel by reflecting the image signal data of the adjacent left and right pixels of each pixel; and a feedback processor for calculating a first dispersion among three sub-pixels of each pixel, by using the inputted image signal data, calculating a second dispersion among sub-pixels of each pixel, by using the image signal data that has been converted by the rendering processor, and re-converting the image signal data that has been converted by the rendering processor into the original image signal data if the second dispersion is equal to or smaller than the first dispersion in the same pixel.

Two of the three sub-pixels may correspond to the same column electrode, and each pixel may correspond to the 3/2 number of row electrodes. Of the two column electrodes arranged at the three sub-pixels, one can be arranged to pass through the two sub-pixels adjacent in a column direction and the other can be arranged to pass through the remaining sub-pixel.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a top plan view of a portion of an arrangement of pixels and electrodes of a Plasma Display Panel (PDP).

FIG. 2 is a top plan view of a portion of an arrangement of pixels and electrodes of a PDP.

FIG. 3 is a schematic conceptual view of a plasma display device according to an exemplary embodiment of the present invention.

FIG. 4 is an exploded perspective view of a portion of the PDP according to the first exemplary embodiment of the present invention.

FIG. 5 is a top plan view of a portion of an arrangement of pixels and electrodes of the PDP according to the first exemplary embodiment of the present invention.

FIG. 6 is a top plan view of a portion of an arrangement of pixels and electrodes of a PDP according to a second exemplary embodiment of the present invention.

FIG. 7A is a conceptual view of a method of alternately arranging cyan-biased and magenta-biased image signal data as image signal data of left and right pixels of a black vertical line.

FIG. 7B is a conceptual view of a method of alternately arranging cyan-biased and magenta-biased image signal data as image signal data of left and right pixels of a black horizontal line.

FIG. 8A is a conceptual view of a method of alternately arranging cyan-biased and magenta-biased image signal data as image signal data of left and right pixels of a white vertical line.

FIG. 8B is a conceptual view of a method of alternately arranging cyan-biased and magenta-biased image signal data as image signal data of left and right pixels of a white horizontal line.

FIG. 9 is a partial block diagram of the controller 200 of FIG. 3.

FIG. 10 is a view of an arrangement of pixels of a pixel structure of the PDP of FIG. 5.

FIGS. 11A and 11B are respective views of an example of a rendering method applied for each image signal data according to an exemplary embodiment of the present invention.

FIG. 12A is a view of final image signal data of the image signal data of FIG. 11A.

FIG. 12B is a view of final image signal data of the image signal data of FIG. 11B.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. In order to clarify the present invention based on the attached drawings, parts unrelated to the description have been omitted and like reference numerals designate like elements throughout the specification.

It will be understood that, in the entire specification, when one portion is connected to another portion, it can be directly connected to another portion or it can be electrically connected with intervening elements present therebetween.

When a part “includes” an element, it means that it may include a different element, rather than excluding the different element, so long as there is no description to the contrary.

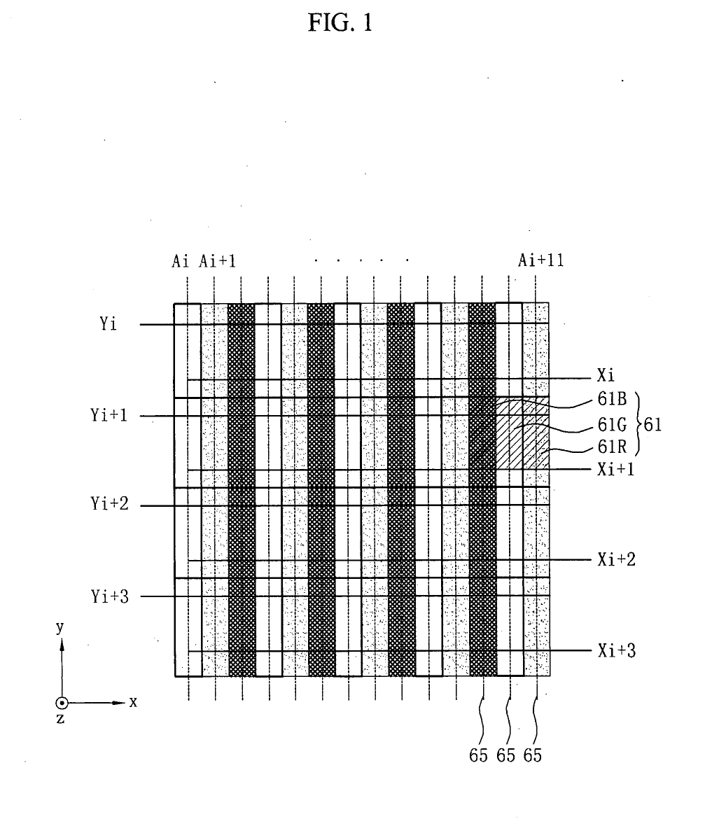

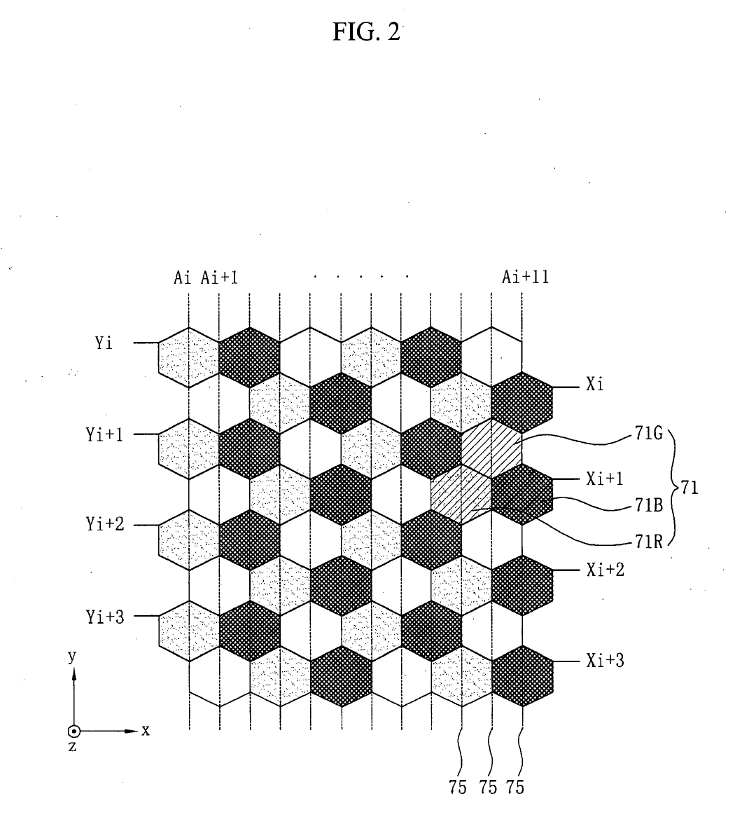

FIGS. 1 and 2 are plan views of arrangements of pixels and electrodes of a PDP. FIG. 1 is a view of a PDP having a stripe barrier rib structure and FIG. 2 is a view of a PDP having a delta barrier rib structure.

As shown in FIG. 1, in the PDP having the stripe barrier rib structure, discharge cells are formed between the sustain electrodes (Xi˜Xi+3) and the scan electrodes (Yi˜Yi+3) that face each other, while forming a discharge gap therebetween.

One pixel 61 includes adjacent red, green, and blue discharge cells 61R, 61G, and 61B, namely, three sub-pixels. The address electrodes are formed to respectively pass through the discharge cells 61R, 61G, and 61B constituting the single pixel 61.

Accordingly, as shown in FIG. 1, in the case of 16 pixels 61, a total of 12 address electrodes 65 Aj˜Aj+1 are required, namely, three address electrodes for each pixel. In this respect, since the PDP has been developed to have a high resolution, the discharge cells are highly integrated so the address electrodes 65 passing through the discharge cells are close to each other, increasing the capacitance (C) between adjacent address electrodes, which inevitably increases energy (=CV²f) consumption.

With reference to FIG. 2, in the PDP having the delta barrier rib structure, the discharge cells are partitioned into independent spaces by barrier ribs, and a single pixel 71 includes red, green, and blue discharge cells 71R, 71G, and 71B disposed adjacent to each other and that form a triangle. The address electrodes 75 are formed to respectively pass through the discharge cells 71R, 71G, and 71B that constitute the single pixel 71.

In this case, for sixteen pixels 71, a total of twelve address electrodes Aj˜Aj+11 are required, namely, three address electrodes for each pixel 71. In this respect, since the PDP has been developed to have a high resolution, the discharge cells are highly integrated so the address electrodes 75 passing through the discharge cells are close to each other, increasing the capacitance (C) between adjacent address electrodes, which inevitably increases energy (=CV²f) consumption.

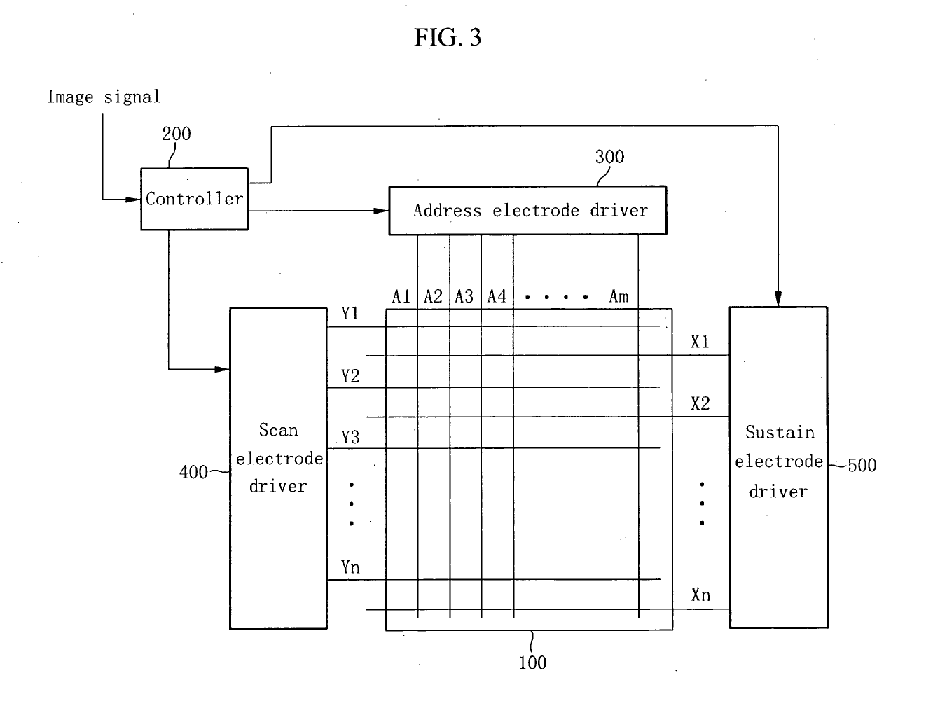

FIG. 3 is a schematic conceptual view of a plasma display device according to an exemplary embodiment of the present invention.

As shown in FIG. 3, a plasma display device according to the exemplary embodiment of the present invention includes a plasma display panel (PDP) 100, a controller 200, an address electrode driver 300, a scan electrode driver 400, and a sustain electrode driver 500.

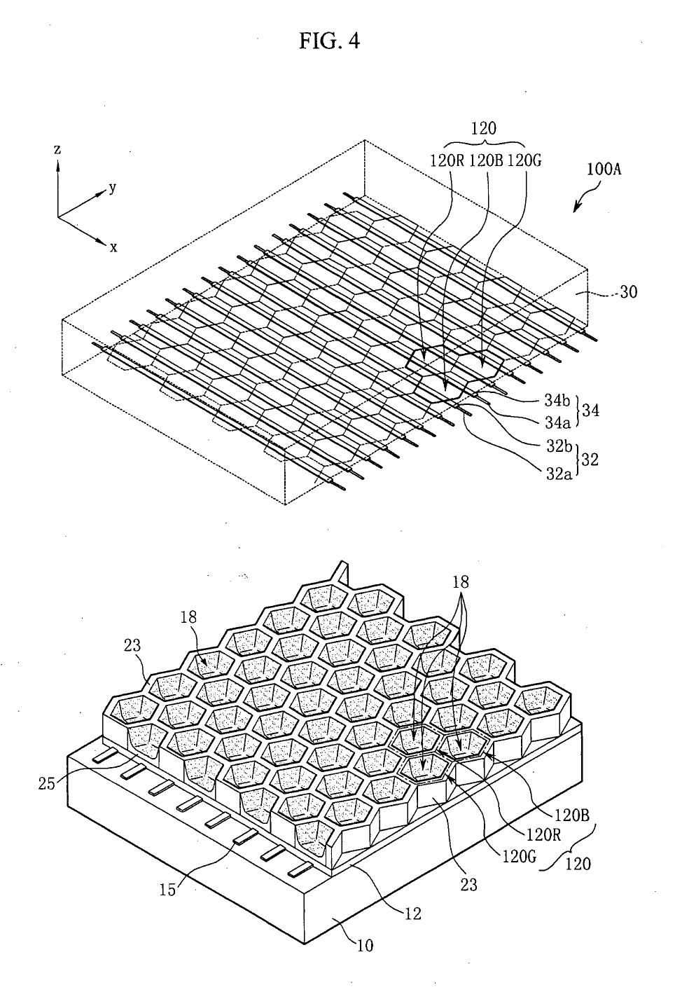

The PDP includes a plurality of row electrodes extending in a row direction and performing scanning and display functions, and a plurality of column electrodes extending in a column direction and performing an address function. In FIG. 3, the column electrodes are shown as the address electrodes A1˜Am and the row electrodes are shown as the sustain electrode X1˜Xn and scan electrodes Y1˜Yn that make pairs. FIG. 3 is a schematic block diagram of the PDP 100 according to the exemplary embodiment of the present invention, and a detailed structure of the PDP is described below with reference to FIGS. 4 to 6.

The controller 200 receives an image signal from the outside and outputs an address drive control signal, a sustain electrode drive control signal, and a scan electrode control signal, and divides a single sub-field into a plurality of sub-fields each with a weight value. Each sub-field includes an address period for selecting discharge cells to be illuminated among a plurality of discharge cells and a sustain period.

The address electrode driver 300 receives the address electrode drive control signal from the controller 200 and supplies a display data signal for selecting a discharge cell to the address electrodes A1˜Am. The scan electrode driver 400 receives the scan electrode drive control signal from the controller 200 and supplies a driving voltage to the scan electrodes Y1˜Yn. The sustain electrode driver 500 receives the sustain electrode drive control signal from the controller 200 and supplies a driving voltage to the sustain electrodes X1˜Xn.

A reduction in the number of address electrodes in the PDP according to the exemplary embodiment of the present invention is described below with reference to FIGS. 4 to 6.

FIG. 4 is an exploded perspective view of a portion of the PDP according to the first exemplary embodiment of the present invention.

As shown in FIG. 4, the PDP according to the first exemplary embodiment of the present invention is a delta PDP in which three sub-pixels for generating red, green, and blue visible light are arranged in a triangular form to form a single pixel.

In more detail, the PDP includes a rear substrate 10 and a front substrate 30 that are disposed to be substantially parallel to each other with a gap therebetween that is encapsulated.

Patterned barrier ribs 23 are disposed to divide pixels 120 between the rear and front substrates 10 and 30. A single pixel 120 includes three sub-pixels 120R, 120G, and 120B arranged in a triangular form as mentioned above.

The sub-pixels 120R, 120G, and 120B respectively include discharge cells 18, and the discharge cells 18 are partitioned by the barrier ribs 23.

In the first exemplary embodiment of the present invention, a planar shape of the sub-pixels 120R, 120G, and 120B is substantially a hexagonal shape, so the barrier ribs 23 partitioning the sub-pixels 120R, 120G, and 120B are also formed in the hexagonal shape. Accordingly, the respective discharge cells 18 of respective sub-pixels 120R, 120G, and 120B have a hexagonal box shape with their upper portions opened.

A discharge gas, including xenon (Xe), neon (Ne), etc., that is required for a plasma display is injected into the discharge cells 18. Corresponding red, green, and blue phosphor layers 25 are formed at the sub-pixels 120R, 120G, and 120B that respectively generate red, green, and blue visible light. The phosphors 25 are formed at the bottom of each discharge cell 18 and at the sides of each barrier rib 23.

The address electrodes 15 extend along a first direction (y-axis direction in the drawing) on the rear substrate 10 and are disposed side by side along a second direction (x-axis direction in the drawing). The address electrodes 15 are arranged to pass a lower portion (namely, between the rear substrate and the barrier ribs) of each discharge cell 18.

A dielectric layer 12 is formed on the entire surface of the rear substrate 10 and covers the address electrodes 15. Namely, the address electrodes 15 are positioned below the layer formed by the barrier ribs 23.

The sustain electrodes 32 and the scan electrodes 34 are formed to extend along the second direction (x-axis direction) on the front substrate 30. The sustain electrodes 32 and the scan electrodes 34 form discharge gaps in each discharge cell 18 by corresponding to each other. The sustain electrodes 32 and the scan electrodes 34 are alternately arranged along the first direction (y-axis direction).

The sustain electrodes 32 and the scan electrodes 34 respectively include bus electrodes 32a and 34a and transparent electrodes 32b and 34b. The bus electrodes 32a and 34a are formed to extend along the second direction (x-axis direction) on the front substrate 30. The transparent electrodes 32b and 34b with a larger width than that of the bus electrodes 32a and 34a cover the bus electrodes 32a and 34a along the second direction (x-axis direction).

The bus electrodes 32a and 34a can be made of a metal having a good electrical conductivity. The bus electrodes 32a and 34a can be formed with a line width that can be minimized within a range that their conductivity is secured to minimize shielding of the visible light generated by the discharge cells 18 in driving the PDP.

The transparent electrodes 32b and 34b are made of a transparent material, such as Indium Tin Oxide (ITO), formed to extend in the second direction (x-axis direction) together with the bus electrodes 32a and 34a. Accordingly, a pair of transparent electrodes 32b and 34b are arranged in a facing manner with a gap therebetween in a single discharge cell 18.

A dielectric layer (not shown) can be formed on the entire surface of the front substrate 30, covering the sustain electrodes 32 and the scan electrodes 34, on which a passivation layer of MgO (not shown) can be formed.

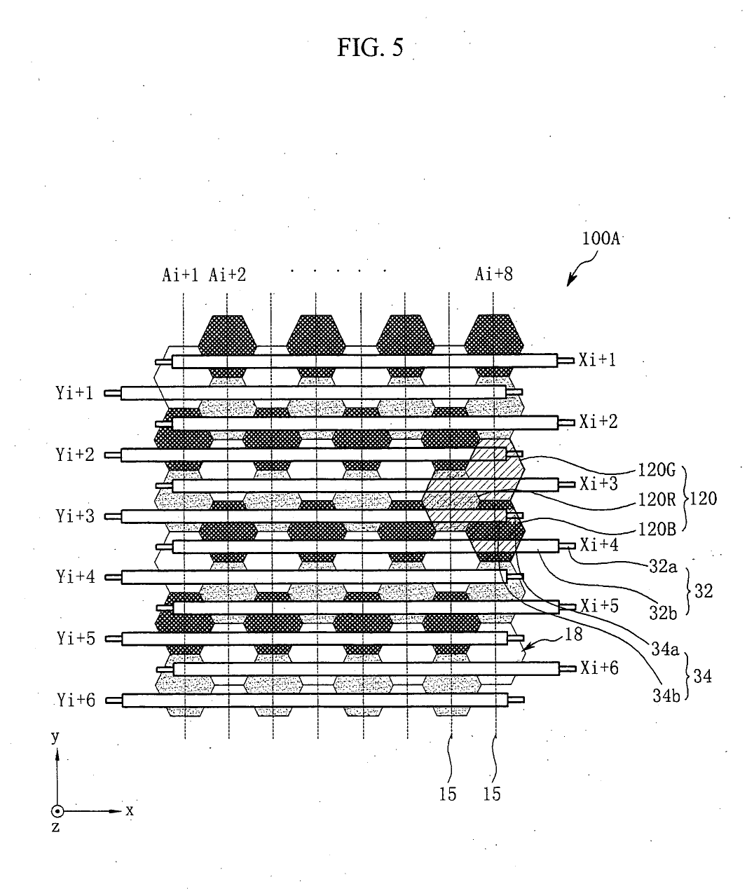

FIG. 5 is a top plan view of a portion of an arrangement of pixels and electrodes of the PDP according to the first exemplary embodiment of the present invention.

With reference to FIG. 5, in the first exemplary embodiment of the present invention, two address electrodes 15 correspond to each pixel 120. Each pixel 120 includes three sub-pixels 120R, 120G, and 120B, and the three sub-pixels 120R, 120G, and 120B respectively generate red, green, and blue visible light.

The sub-pixels 120R, 120G, and 120B constituting the pixel 120 are disposed such that the centers of the sub-pixels 120R, 120G, and 120B form an isosceles triangle together. Of the three discharge cells 18, namely, the sub-pixels 120R, 120G, and 120B that constitute the pixel, two discharge cells 18 are disposed to be adjacent side by side in the first direction (y-axis direction). Such a disposition increases a discharge space in the first direction (y-axis direction) to form a space suitable for discharging, having an effect that the margin can be improved.

Of the three sub-pixels 120R, 120G, and 120B constituting a single pixel 120, two sub-pixels correspond to the same address electrode 15. Two scan electrodes 34 are disposed in the single pixel 120. Namely, the discharge of the three sub-pixels 120R, 120G, and 120B constituting the single pixel 120 can be determined by the two address electrodes 15 and the two scan electrode 34.

In more detail, of the two address electrodes 15 disposed in each pixel, one address electrode 15 passes through two adjacent sub-pixels 120G and 120B in the first direction (y-axis direction) and the other address electrode 15 passes through the remaining one sub-pixel 120R. Namely, the two sub-pixels 120G and 120B corresponding to one address electrode 15 have phosphor layers 25 that respectively generate visible light of different colors.

Of the two scan electrodes 34 disposed in each pixel 120, one scan electrode 34 Yi+3 is disposed to pass through the two adjacent sub-pixels 120R and 120B in the second direction (x-axis direction) and the other scan electrode Yi+2 is disposed to pass through the remaining one sub-pixel 120G. Namely, the two sub-pixels where one scan electrode 34 Yi+3 is disposed have the phosphor layers 25 that respectively generate visible light of different colors.

Because the scan electrodes 34 and the sustain electrodes 32 correspond together with each discharge cell 18, two sustain electrodes 32 Xi+3 and Xi+4 are also disposed in the single pixel 120. The sustain electrodes 32 Xi+3 and Xi+4 and the scan electrodes Yi+3 and Yi+2 are disposed to face each other in the single pixel 120.

The arrangement of the sustain electrodes 34 and the scan electrodes 32 corresponding to the pixel 120 can be set in the above-described manner or in a different manner according to the selection of the repeatedly disposed pixels 120.

In the first exemplary embodiment of the present invention, the discharge cells 18 constituting the sub-pixels 120R, 120G, and 120B have a hexagonal planar shape. Accordingly, the discharge cells 18 make boundaries by their sides in the six directions. An extending line of the boundary between a pair of discharge cells adjacent along the direction (y-axis direction) parallel to the address electrode 15 passes through the center of the neighbor discharge cell 18 along the direction (x-direction) perpendicular to the address electrode 15.

In the first exemplary embodiment of the present invention, while the three sub-pixels 120R, 120G, and 120B that constitute the single pixel 120 are formed such that their centers form a triangle together, the sustain electrodes 32 and the scan electrodes 34 are formed in a linear shape. Accordingly, the sustain electrodes 32 and the scan electrodes 34 are disposed to pass through at least one of the sub-pixels 120R, 120G, and 120B in the second direction (x-axis direction) on the plane. In the first exemplary embodiment of the present invention, the sustain electrodes 32 and the scan electrodes 34 are disposed to respectively pass through two of the three sub-pixels.

Because the scan electrode 34 Yi+3 passes through the two adjacent sub-pixels 120R and 120B in the second direction (x-axis direction) in the single pixel 120, a common voltage is supplied to the two sub-pixels 120R and 120B, and the other scan electrode 34 Yi+2 passes through one sub-pixel 120G in the pixel 120, and a voltage is supplied to the sub-pixel 120G.

Because the sustain electrodes 32 are disposed to face the scan electrodes 34, the scan electrode 32 Xi+4 faces the scan electrode 34 Yi+3 and passes through one sub-pixel 120B in the single pixel 120, voltage is supplied to the single sub-pixel 120B. Because the other sustain electrode 32 Xi+3 corresponds to the two remaining sub-pixels 120R and 120G in the single pixel 120, voltage is commonly supplied to the two sub-pixels 120R and 120G. The sustain electrode 32 Xi+3 is arranged between the scan electrode 32 Yi+3 and the scan electrode 32 Yi+2 along the first direction (y-axis direction).

As shown in FIG. 5, when four columns of pixels 120 are arranged along the second direction (x-axis direction) and four rows of pixels 120 are arranged along the first direction (y-axis direction), six scan electrodes 34 and eight address electrodes 15 passes through the sixteen (4×4=16) pixels. That is, two address electrodes 15 and the 3/2 number of scan electrodes 34 correspond to each pixel 120. Like the scan electrodes, the 3/2 number of sustain electrodes 32 correspond to each pixel 120.

That is, in the arrangement of the n×n number of pixels, when two address electrodes 15 and the 3/2 number of scan electrodes 34 correspond to each pixel 120, the address electrodes 15 and the scan electrodes 34 satisfy a ratio of Equation 1 below:

Herein, “n” is a natural number indicating the number of pixels arranged continuously in the horizontal or vertical direction.

The number of address electrodes: the number of scan electrodes=4:3 Equation 1:

In more detail, in the pixel arrangement with 4×4 pixels, a total of sixteen pixels 120 are arranged. In this case, because two address electrodes 15 correspond to each pixel column, a total of eight address electrodes Aj+1˜Aj+8 correspond to a total of sixteen pixels 120, and because the 3/2 number of scan electrodes 34 correspond to each pixel row, a total of six scan electrodes 34 Yi+1˜Yi+6 correspond to the total of sixteen pixels 120. The sustain electrodes 32 correspond to each pixel in the same manner as the scan electrodes 34, so six sustain electrodes Xi+1˜Xi+6 correspond to a total of sixteen pixels 120.

In the pixel arrangement, two adjacent sub-pixels 120G and 120B corresponding to the same address electrode 15 have phosphor layers each with a different color. In this case, the sub-pixels 120R, 120G, and 120B having phosphor layers each with a different color may all correspond to one address electrode 15.

Compared to the PDP of FIGS. 1 and 2, when a total of sixteen pixels (4×4 pixels) are considered, the PDP of FIGS. 1 and 2 requires twelve address electrodes while the first exemplary embodiment of the present invention requires only eight address electrodes. Thus, in the first exemplary embodiment of the present invention, for the same number of pixels, the number of address electrodes can be reduced.

Namely, in the PDP according to the first exemplary embodiment of the present invention, since the number of address electrodes is reduced by one-third compared with that of comparable PDPs, the design of the address electrodes is easier. Accordingly, power consumption of the address electrodes can also be reduced by one-third compared with that of comparable PDPs. In addition, peak power per address element (e.g., a Tape Carrier Package (TCP)) for controlling the address electrodes can be also reduced by one-third compared with that of comparable PDPs.

Comparable PDPs require a total of four scan electrodes while the exemplary embodiment of the present invention requires a total of six scan electrodes. Accordingly, in the first exemplary embodiment of the prevent invention, the number of scan electrodes can increase for the same number of pixels.

The scan element is low-priced compared with the address electrode, so in spite of the increase in the number of scan electrodes, the reduction of the number of address elements can contribute to an overall reduction in the cost of the circuit for driving the panel.

A PDP 100B according to a second exemplary embodiment of the present invention is described as follows. The PDP according to the second exemplary embodiment of the present invention has a similar structure and operation as those of the first exemplary embodiment, so a repeated explanation thereof has been omitted.

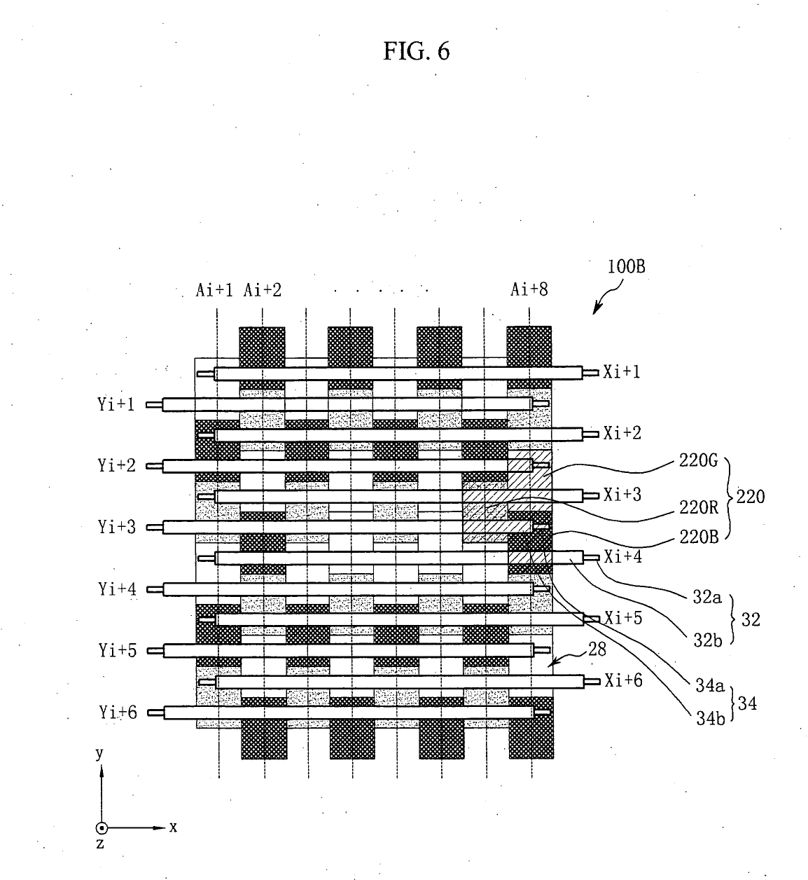

FIG. 6 is a top plan view of a portion of an arrangement of pixels and electrodes of the PDP according to the second exemplary embodiment of the present invention.

With reference to FIG. 6, in the second exemplary embodiment of the present invention, discharge cells 28 constituting each of sub-pixels 220R, 220G, and 220B are formed in a rectangular planar shape. The planar shape of the discharge cells 28 can be implemented in various manners. Like in the first exemplary embodiment of the present invention, the sub-pixels 220R, 220G, and 220B are formed such that their centers form a triangle together, and the number of address electrodes 15 can be reduced. Accordingly, power consumption can be reduced.

Table 1 below shows a comparison among the PDP according to the exemplary embodiment of the present invention and those of Comparative Examples 1 and 2 with the items including the number of TCPs connected with each address electrode, the price of the TCP, the number of scan terminals connected with the scan electrodes, the price of a scan element connected with the scan terminal, and the overall circuit price.

The exemplary embodiment uses a PDP according to the first and second exemplary embodiments of the present invention by adopting a dual driving scheme with resolution of 1920×1080 (FHD class). Comparative Example 1 uses a PDP with a stripe sub-pixel arrangement by adopting the dual driving scheme with resolution of 1920×1080 (FHD class). Comparative Example 2 uses a PDP with a delta sub-pixel arrangement by adopting the dual driving scheme with resolution of 1920×1080 (FHD class).

TABLE 1

| | | | | Price of | |
|---|---|---|---|---|---|
| | | | Number of | scan | Price of |
| | Number | TCP price | scan | Terminal | Circuit |
| Classification | of TCPs | (Won) | terminals | (Won) | (Won) |
| exemplary | 80 | 320,000 | 1620 | 75,600 | 279,801 |
| embodiment | | | | | |
| Comparative | 120 | 480,000 | 1080 | 55,020 | 419,188 |
| Example 1 | | | | | |
| Comparative | 120 | 480,000 | 1080 | 55,020 | 319,188 |
| Example 2 | | | | | |

As noted in Table 1, in the case of Comparative Examples 1 and 2, the number of TCPs connected to electrodes is 120. When the number of TCPs increases, the address power consumption increases and a distance between adjacent discharge cells decreases. As the adjacent discharge cells becomes closer, crosstalk between address electrodes increases, and accordingly power consumption also increases.

Comparatively, in the exemplary embodiment of the present invention, the number of TCPs connected to the address electrodes is 80, namely, a considerably reduced number compared with Comparative Examples 1 and 2. Accordingly, it can be ascertained that the exemplary embodiment of the present invention consumes the smallest amount of power over the same class of resolution.

It is also noted that the number of scan terminals connected to the scan electrodes in the exemplary embodiment is 1620, a highly increased number compared with 1080 of Comparative Examples 1 and 2. The increase in the number of scan terminals increases the number of scan elements. In this respect, however, because the price of the scan element is relatively low compared with that of the TCP, the overall circuit price of the exemplary embodiment of the present invention is relatively low compared with those of Comparative Examples 1 and 2.

When the centers of the sub-pixels constituting pixels form a triangle together as in the PDP according to the exemplary embodiment of the present invention, the number of address electrodes can be reduced but with a problem in that readability of expressed characters is degraded. In the case of the PDP of FIG. 1, the structure of pixels, namely, the arrangement of sub-pixels constituting the single pixel is always the same, but in the case where the centers of sub-pixels form a triangle together as in the exemplary embodiment of the present invention, the sub-pixels have mutually different arrangements. Thus, the mutually different arrangements of sub-pixels would degrade readability of characters unless they are properly compensated.

In particular, in the PDP according to the exemplary embodiment of the present invention, the centers of the sub-pixels (120R, 120G, and 120B in FIG. 5 and 220R, 220G, and 220B in FIG. 6) forming the single pixel form a triangle together and one side of the triangle is in the same direction as the vertical line (namely, in the direction that the address electrodes extend) displayed on the PDP. Accordingly, when a black or white vertical line of a character is expressed on the PDP, the vertical line regularly contacts the green sub-pixels and appears in a zigzag form.

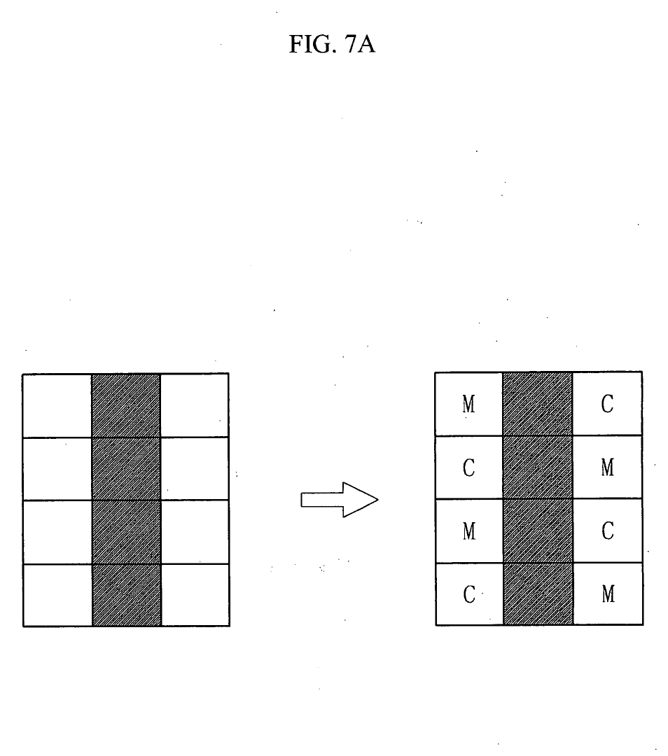

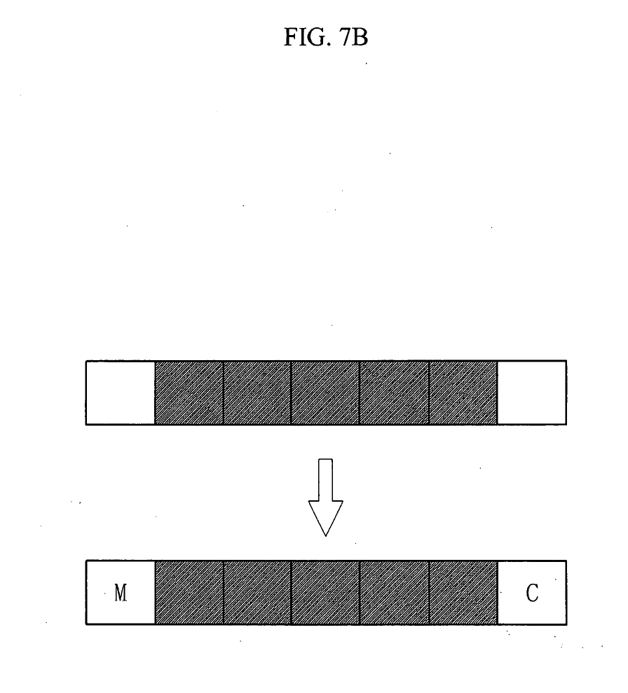

A solution to the problem of degradation of the readability of characters as the sub-pixels have the mutually different arrangements is described below with reference to FIGS. 7 to 12.

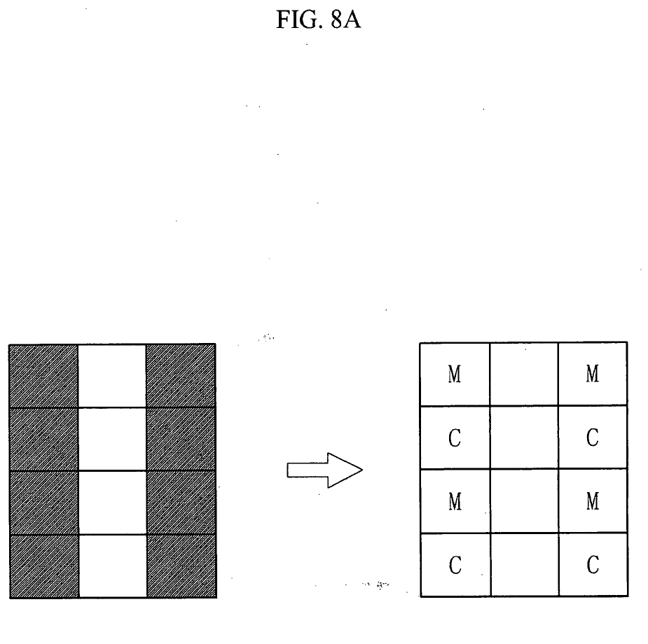

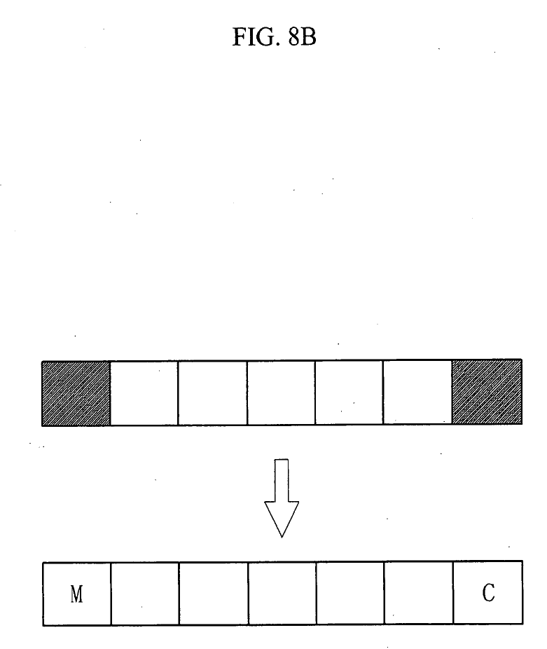

In order to solve the problem, as shown in FIGS. 7A and 8A, in the exemplary embodiment of the present invention, an image is processed such that image signal data of left and right pixels of the black or white vertical line of a displayed character are changed to cyan-biased (or green-biased) image signal data and magenta-biased image signal data compared with the original image signal data, which are then alternately disposed at the adjacent pixel regions.

FIG. 7A is a conceptual view of a method of alternately arranging cyan-biased and magenta-biased image signal data as image signal data of left and right pixels of a black vertical line, and FIG. 8A is a conceptual view showing a method of alternately arranging cyan-biased and magenta-biased image signal data as image signal data of left and right pixels of a white vertical line.

In FIGS. 7A and 8A, the shaded parts indicate pixels representing black and non-shaded parts indicate pixels representing white. “M” indicates a portion that has been converted into magenta-biased image signal data from the original image signal data and “C” indicates a portion that has been converted into cyan-biased image signal data from the original image signal data.

As shown in FIGS. 7A and 8A, in the exemplary embodiment of the present invention, the image signal data of the left and right pixels of the black vertical or the white vertical line are changed to the relatively cyan (C)-biased and magenta (M)-biased image signal data compared with the original image signal data and alternately arranged at the adjacent pixel regions.

As shown in FIG. 7A, as the image signal data of the left pixels of the black vertical line, relatively magenta (M)-biased and cyan (C)-biased image signal data compared with the original image data are alternately arranged (namely, an arrangement of M-C-M-C in the vertical direction), and as the image signal data of the right pixel of the black vertical line, the relatively cyan (C)-biased and magenta (M)-biased image signal data compared with the original image signal data are alternately arranged (namely, an arrangement of C-M-C-M along the vertical line).

FIG. 7A shows that the magenta (M) and cyan (C) are alternately arranged at left and right pixels of the vertical line, but the left and right image signal values of the left and right pixels of one vertical line can be disposed in a manner of magenta (M) and magenta (M) or cyan (C) and cyan (C) so long as magenta (M) and cyan (C) are alternately disposed in the direction of the vertical line.

As shown in FIG. 8A, in the case of the white vertical line, the left and right pixel values adjacent to the white vertical line are relatively changed to the magenta (M)-biased or cyan (C)-biased image signal data compared with the original image signal data and disposed.

FIG. 8A shows the arrangement of magenta (M)-magenta (M) or cyan (C)-cyan (C), but, like the case of the black vertical line, the image signal values of the left and right pixels of the vertical line can be disposed in a manner of magenta (M)-cyan (C) or cyan (C)-magenta (M) so long as magenta (M) and cyan (C) are alternately disposed in the direction of the vertical line.

In the exemplary embodiment of the present invention, as shown in FIGS. 7B and 8B, an image is processed such that the left and right image signal data of the black horizontal line or white horizontal line are changed to relatively cyan-biased (or green-biased) image signal data or magenta-biased image signal data compared with the original image signal data and alternately disposed at the adjacent pixel parts.

FIG. 7B is a conceptual view of a method of alternately arranging cyan-biased and magenta-biased image signal data as image signal data of left and right pixels of a black horizontal line, and FIG. 8B is a conceptual view showing a method of alternately arranging cyan-biased and magenta-biased image signal data as image signal data of left and right pixels of a white horizontal line.

As shown in FIG. 7B, the image signal data of the left and right pixels adjacent to the black horizontal line are changed from the original image signal data to the magenta (M)-biased image signal data and cyan (C)-biased image signal data and disposed.

As shown in FIG. 8B, the image signal data of the left and right pixels adjacent to the white horizontal line are changed from the original image signal data to the magenta (M)-biased image signal data and cyan (C)-biased image signal data and disposed.

The method of converting the original image signal data of left and right pixels adjacent to the black vertical line, the white vertical line, the black horizontal line, and the white horizontal line into the magenta-biased or cyan-biased image signal data is described in detail as follows.

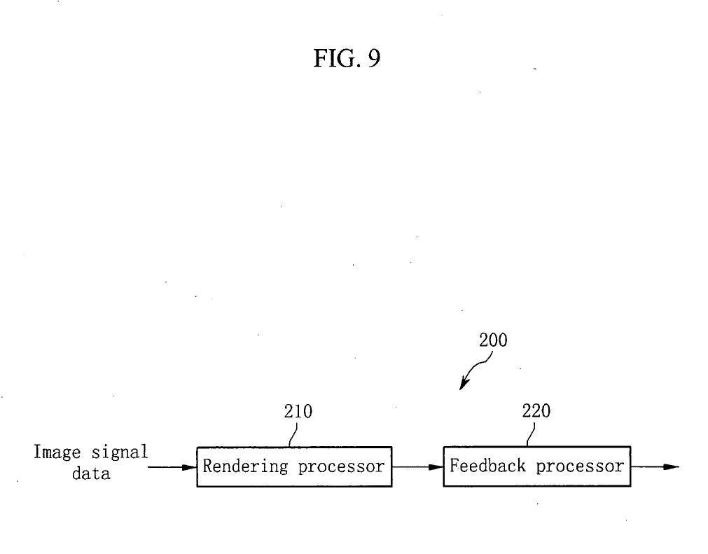

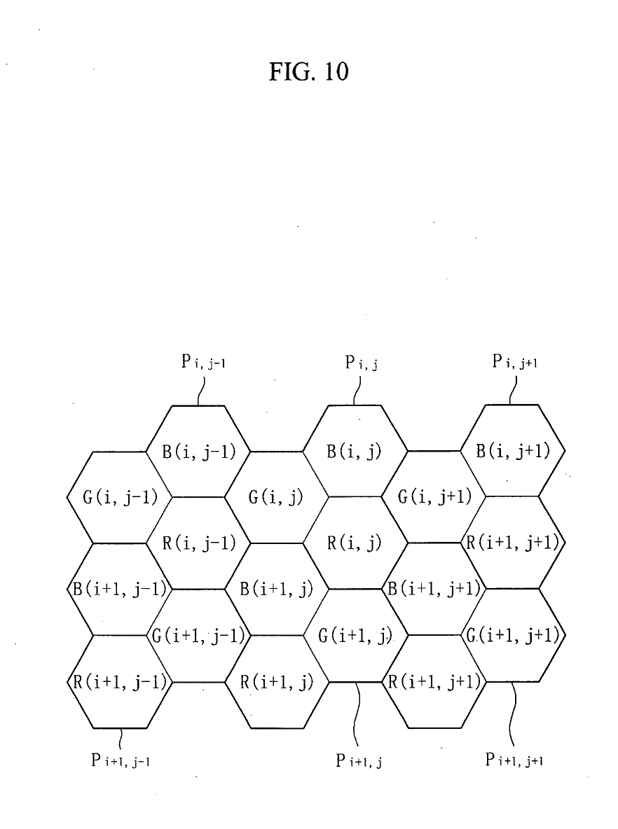

FIG. 9 is a partial block diagram of the controller 200 of FIG. 3, and FIG. 10 is a view of an arrangement of pixels of a pixel structure of the PDP of FIG. 5. In FIG. 10, R(i, j), G(i, j), B(i, j) represent image signal data of red, green, and blue sub-pixels of the pixels P_{i,j} at the i-th row and the j-th column.

As shown in FIG. 9, the controller 200 includes a rendering processor 210 and a feedback processor 220. The controller 200 may additionally includes an inverse gamma corrector (not shown) for performing inverse gamma correction on inputted image data.

The rendering processor 210 mixes the image signal data of the left or right pixels at a certain ratio and processes rendering thereon by using inputted image data or data that has been corrected by the inverse gamma corrector to convert the image signal data of the left and right pixels of the black vertical line, the white vertical line, the black horizontal line, and the white horizontal line into magenta-biased or cyan-biased image signal data.

The method of performing rendering by the rendering processor is described in detail as follows.

In the pixel arrangement of FIG. 10, image signal data R(i, j), G(i, j), and B(i, j) of the pixel Pi,j at the i-th row and j-th column are rendered by Equation 2 to Equation 4 below so as to be converted into R′(i, j), G′(i, j), and B′(i, j).

R′(i,j)=R(i,j)×m/(m+n)+R(i,j+1)×n/(m+n) Equation 2:

G′(i,j)=G(i,j)×m/(m+n)+G(i,j−1)×n/(m+n) Equation 3:

B′(i,j)=B(i,j)×m/(m+n)+B(i,j+1)×n/(m+n) Equation 4:

In Equation 2 to Equation 4, “m” has a greater value than “n” and is set in consideration of an influence of adjacent sub-pixels to obtain an optimum image. Because “m” is greater than “n”, the converted image signal data is more affected by the original image signal data.

As expressed by Equation 2, the converted image signal data R′(i, j) is obtained by combining the image signal data R(i, j) of its own and the image signal data R(i, j+1) at a certain ratio. Namely, the image signal data R′(i, j) is affected by the image signal data R(i, j+1) of the red sub-pixel of the adjacent (j+1)th column.

As expressed by Equation 3, the converted image data G′(i, j) is obtained by combining the image data G(i, j) of its own and the image data G(i, j−1) at a certain ratio. Namely, unlike the converted image data R′(i, j), the converted image data G′(i, j) is affected by the image signal data G(i, j−1), the image data of the green sub-pixel of the pixel of the adjacent (j−1)th column.

As expressed by Equation 4, the converted image data B′(i, j) is obtained by combining the image signal data B(i,j) of its own and the image signal data B(i,j+1) at a certain ratio. Namely, the converted data B′(i, j) is affected by the image signal data B(i, j+1) of the blue sub-pixel of the adjacent (+1)th column.

In the pixel (P_{i+1,j}) of the (i+1)th row and the j-th column, R(i+1, j), G(i+1, j), and B(i+1, j) are rendered by Equation 5 to Equation 7 so as to be converted into image signal data R′(i+1, j), G′(i+1, j), and B′(i+1, j).

R′(i+1,j)=R(i+1,j)×m/(m+n)+R(i+1,j−1)×n/(m+n) Equation 5:

G′(i+1,j)=G(i+1,j)×m/(m+n)+G(i+1,j+1)×n/(m+n) Equation 6:

B′(i+1,j)=B(i+1,j)×m/(m+n)+B(i+1,j−1)×n/(m+n) Equation 7:

Also, in Equation 5 to Equation 7, “m” has a greater value than “n” and is set in consideration of an influence of adjacent sub-pixels to obtain an optimum image. With reference to FIG. 10, the sub-pixel arrangement of the pixel of the (i+1)th column is different in the order from that of the pixel of i-th column, so the influencing adjacent sub-pixels differ as expressed by Equation 5 to Equation 7.

As expressed by Equation 5, the converted image data R′(i+1, j) is obtained by combining the image signal data R′(i+1, j) of its own and the image signal data R(i+1, j−1) at a certain ratio. Namely, the converted image data R′(i+1, j) is affected by the image signal data R(i+1, j−1) of the red sub-pixel of the adjacent (j−1)th column.

As expressed by Equation 6, the converted image data G′(i+1, j) is set by combining the image data G(i+1, j) of its own and the image data G(i+1, j+1) at a certain ratio. Namely, unlike the image data R′(i+1, j), the image data G′(i+1, j) is affected by the image signal data G(i+1, j+1), the image data of the green sub-pixel of the pixel of the adjacent (j+1)th column.

As expressed by Equation 7, the converted image data B′(i+1, j) is obtained by combining the image signal data B(i+1,j) of its own and the image signal data B(i+1,j−1) at a certain ratio. Namely, the converted image data B′(i+1, j) is also affected by the image signal data B(i+1, j−1) of the blue sub-pixel of the adjacent (j−1)th column.

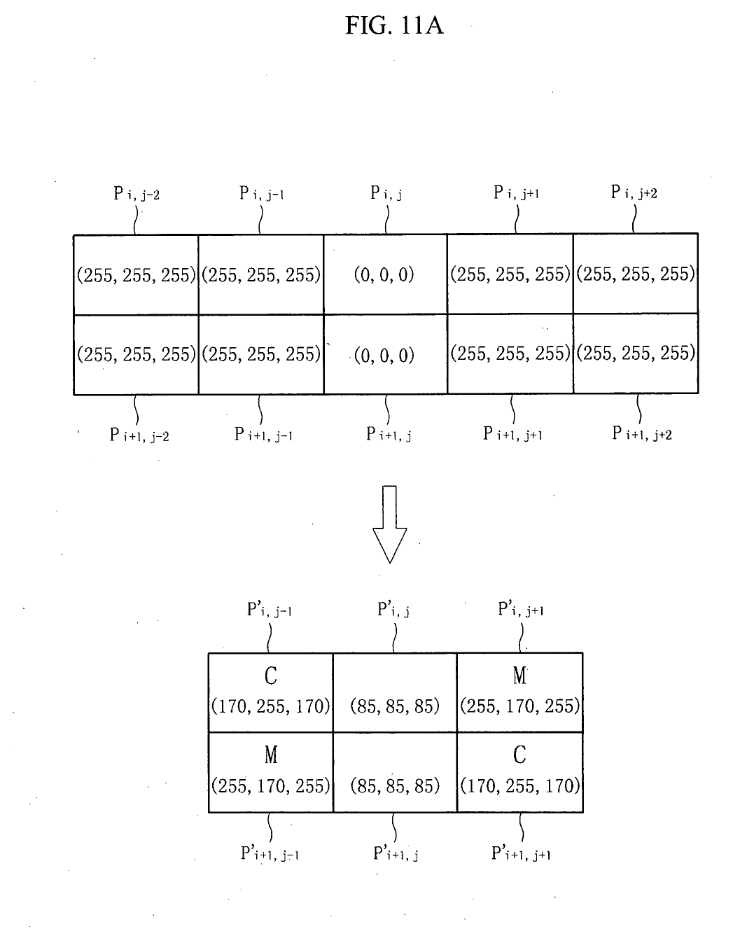

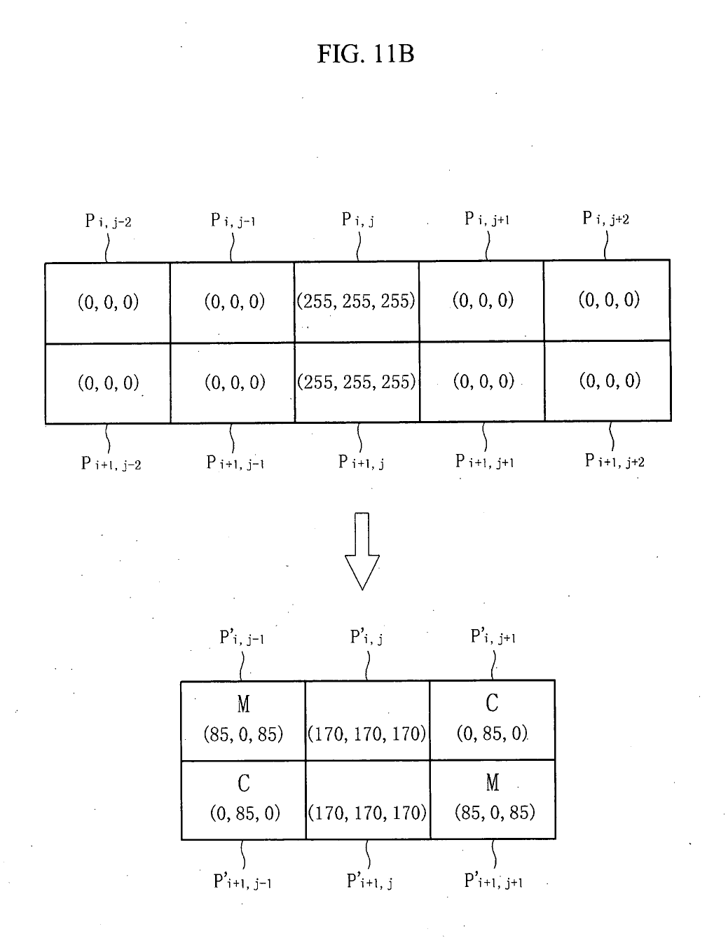

FIGS. 11A and 11B are respective views of an example of a rendering method applied for each image signal data according to the exemplary embodiment of the present invention. Specifically, FIG. 11A shows a case in which Equation 2 to Equation 7 are applied to the image signal data indicating the black vertical line, and FIG. 11B shows a case in which Equation 2 to Equation 7 are applied to the image signal data indicating the white vertical line.

In FIGS. 11A and 11B, values in the parentheses sequentially indicate image signal data of the red sub-pixel, green sub-pixel, and blue sub-pixel. In Equation 2 to Equation 7, it is assumed that “m” is 2 and “n” is 1. In FIGS. 11A and 11B, converted data with respect to pixels P_{i,j-2}, P_{i+1,j-2}, P_{i,j+2}, and P_{i+1,j+2} are determined by adjacent pixels, so they are not shown for the sake of convenience.

With reference to FIG. 11A, when Equation 2 to Equation 4 are applied, image signal data of a pixel P_{i,j-1} is converted from P_{i,j-1}=(255, 255, 255) to P′_{i,j-1}=(170, 255, 170), and when Equation 5 to Equation 7 are applied, image signal data of a pixel P_{i+1,j+1} is converted from P_{i+1,j+1}=(255, 255, 255) to P′_{i+1,j+1}=(170, 255, 170). Namely, the pixels P_{i,j-1} and P_{i+1,j+1} are respectively converted from their original image signal data to the cyan-biased image signal data.

In general, when the original image signal is converted into the cyan-biased image signal data, an average ((ΔR+ΔB)/2) of a variation amount of the image signal data of the red and blue sub-pixels is greater than a variation amount (ΔG) of the image signal data of the green sub-pixel. In other words, when the image signal data of the red and blue sub-pixels decrease or when the image signal data of the green sub-pixel increase, the original image signal data is converted into the cyan-biased image signal data. In the pixels P_{i,j-1} and P_{i+1,j+1}, because the image signal data of the red and blue sub-pixels are relatively small compared with the original image signal data, they are converted into the cyan-biased image signal data.

When Equation 2 to Equation 4 are applied, the image signal data of the pixel P_{i,j+1} is converted from P_{i,j+1}=(255, 255, 255) to P′_{i,j+1}=(255, 170, 255), and when Equation 5 to Equation 7 are applied, the video signal data of the pixel P_{i+1,j-1} are converted from P_{i+1,j-1}=(255, 255, 255) to P′_{i+1,j-1}=(255, 170, 255). Namely, in the pixels P_{i,j+1} and P_{i+1,j-1}, the original image signal data are respectively converted into the magenta-biased image signal data. In general, when the original image signal data is converted into the magenta-biased image signal data, the average ((ΔR+ΔB)/2) of the variation amount of the image signal data of the red and blue sub-pixels is smaller than the variation amount (ΔG) of the image signal data of the green sub-pixel. In other words, when the image signal data of the green sub-pixel decreases or when the image signal data of the red and blue sub-pixel increase, the original image signal data is converted into the magenta-biased image signal data. In the pixels P_{i,j+1} and P_{i+1,j-1}, the image signal data of the green sub-pixel is relatively small compared with the original image signal data, the image signal data is converted into the magenta-biased image signal data.

When Equation 2 to Equation 4 are applied, the image signal data of the pixel P_{i,j} is converted from P_{i,j}=(0, 0, 0) to P′_{i,j}=(85, 85, 85), and when Equation 5 to Equation 7 are applied, the image signal data of the pixel P_{i+1,j} is converted from P_{i+1,j}=(0, 0, 0) to P′_{i+1,j}=(85, 85, 85). Namely, for the image signal data of the pixels P_{i,j} and P_{i+1,j}, their color is not converted but only a luminance level is converted from black to light black.

With reference to FIG. 11B, when Equation 2 to Equation 4 are applied, the image signal data of the pixel P_{i,j-1} is converted from P_{i,j-1}=(0, 0, 0) to P′_{i,j-1}=(85, 0, 85), and when Equation 5 to Equation 7 are applied, the image signal data of the pixel P_{i+1,j+1} is converted from P_{i+1,j+1}=(0, 0, 0) to P′_{i+1,j+1}=(85, 0, 85). Namely, in the pixels P_{i,j-1} and P_{i+1,j+1}, the original image signal data is converted into the magenta-biased image signal data, respectively. In the pixels Pi,j−1 and Pi+1,j+1, because the image signal data of the red and blue sub-pixels become greater than the original image signal data, the image signal data becomes magenta-biased in those pixels.

When Equation 2 to Equation 4 are applied, the image signal data of the pixel P_{i,j+1} is converted from P_{i,j+1}=(0, 0, 0) to P′_{i,j+1}=(0, 85, 0), and when Equation 5 to Equation 7 are applied, the image signal data of the pixel P_{i+1,j-1} is converted from P_{i+1,j-1}=(0, 0, 0) to P′_{i+1,j-1}=(0, 85, 0). Namely, in the pixels P_{i,j+1} and P_{i+1,j-1}, the original image signal data are respectively converted into the cyan-biased image signal data. In the pixels Pi,j+1 and Pi+1,j−1, because the image signal data of the green sub-pixel increases in the original image signal data, the image signal data is converted into the cyan-biased image signal data.

When Equation 2 to Equation 4 are applied, the image signal data of the pixel P_{i,j} is converted from P_{i,j}=(255, 255, 255) to P′_{i,j}=(170, 170, 170), and when Equation 5 to Equation 7 are applied, the image signal data of the pixel P_{i+1,j} is converted from P_{i+1,j}=(255, 255, 255) to P′_{i+1,j}=(170, 170, 170). As for the image signal data of the pixels P_{i,j} and P_{i+1,j} corresponding to the white vertical line, their color is not converted but only a luminance level is converted from white to dark white.

In this manner, as shown in FIGS. 11A and 11B, by applying the rendering method according to the exemplary embodiment of the present invention, the left and right image signal data adjacent to the black or white vertical line is converted into the magenta-biased or cyan-biased image signal data. Thus, the problem that the black vertical line or white vertical line appearing in zigzag form can be solved by applying the rendering method according to the exemplary embodiment of the present invention.

However, when the rendering method is applied, as aforementioned, the color of the pixel corresponding to the black vertical line is not converted but the luminance level is converted into the light black and the color of the pixel corresponding to the white vertical line is not converted and only the luminance level is converted into the dark white. This results in degradation of visibility of the black or white vertical line.

In order to avoid such degradation of visibility, the feedback processor 220 in FIG. 9 re-converts the image signal data at the portion corresponding to the black or white vertical line into the original image signal data. The feedback processor 220 obtains a dispersion of the original image signal data of each pixel and a dispersion of the converted image signal data of each pixel, and determines whether to re-convert the converted image signal data into the original image signal data depending on the degree of a variation amount of the dispersion. Namely, when the dispersion of the original image signal data and that of the converted image signal data are the same or reduced, the feedback processor 220 re-converts the converted image signal data into the original image signal data. The dispersion of the image signal data of each pixel means a dispersion between image signal data of sub-pixels (namely, red, green, and blue sub-pixels) of each pixel.

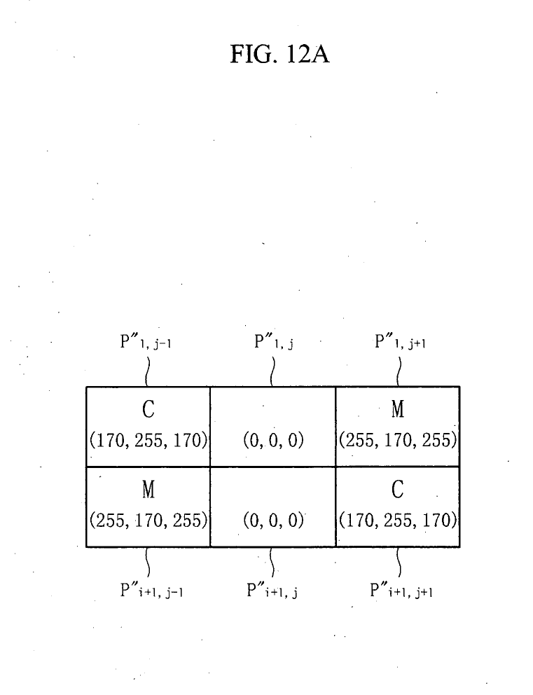

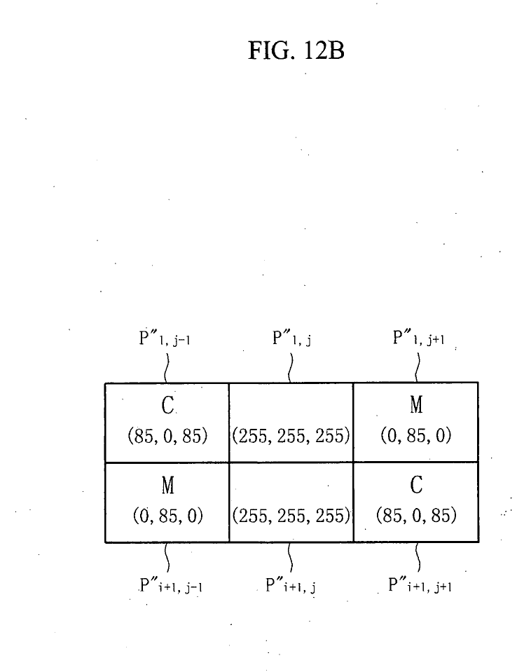

As shown in FIG. 11A, the image signal data of the pixels (i.e., P_{i,j} and P_{i+1,j}) corresponding to the black vertical line are converted from P_{i,j}, P_{i+1,j}=(0, 0, 0) to P′_{i,j}, P′_{i+1,j}=(85, 85, 85) by the rendering processor 210. Because dispersion of (0, 0, 0) is 0, which is 0 of (85, 85, 85), a variation amount of the dispersion at the pixels P_{i,j} and P_{i+1,j} is 0. Accordingly, as shown in FIG. 12A, P′_{i,j}, P′_{i+1,j}=(85, 85, 85) is re-converted into P″_{i,j}, P″_{i+1,j}=(0, 0, 0) by the feedback processor 220. For the other pixels in FIG. 11A, because the dispersion of the converted image signal data have been increased to be larger than that of the original image signal data, they are not re-converted into the original image signal data as shown in FIG. 12A.

With reference to FIGS. 1B and 12B, as for the pixels (i.e., P_{i,j} and P_{i+1,j}) corresponding to the white vertical line, the dispersion (namely, 0) of the converted image signal data and the dispersion (namely, 0) of the original image signal data are the same, so the pixels corresponding to the white vertical line are re-converted from (170, 170, 170) to (255, 255, 255), the original image signal data. In FIG. 11B, for the other remaining pixels, because the dispersion of the converted image signal data have been increased to be larger than that of the original image signal data, they are not re-converted into the original image signal data as shown in FIG. 12B.

The feedback processor 220 may use both the image signal data that has been converted by the rendering processor 210 and the original image signal data by applying a weight value according to a degree of the variation amount of dispersion.

FIG. 12A is a view showing final image signal data of the image signal data as shown in FIG. 11A, and FIG. 12B is a view showing final image signal data of the image signal data as shown in FIG. 11B.

As shown in FIG. 12A, for the image signal data as shown in FIG. 1A, the cyan-biased image signal data and magenta-biased image signal data are alternately arranged at the pixels adjacent to the black vertical line.

As shown in FIG. 12B, for the image signal data as shown in FIG. 1B, the magenta-biased and cyan-biased image signal data are alternately arranged at the pixels adjacent to the white vertical line. Namely, the image signal data are converted by the rendering processor 210 and the feedback processor 220 as shown in FIGS. 7A and 8A.

For the black and white horizontal lines, the image signal data can also be converted as shown in FIGS. 7B and 8B by applying Equation 2 to Equation 7 and by using the rendering processor 210 and the feedback processor 220.

The image processing data processed by the rendering processor 210 and the feedback processor 220 does not have vertical lines that appear zigzag even with the structure in which the centers of the sub-pixels form a triangle together as in the PDP according to the first and second exemplary embodiments of the preset invention. Thus, the visibility and readability of characters can be improved.

In the exemplary embodiment of the present invention, the method of processing images aimed for increasing the visibility and readability of characters in the plasma display device including the PDP with the structure in which the centers of sub-pixels form a triangle together has been described, but without being limited thereto, the present invention can be also applied to any kind of display devices (e.g., LCDs, FEDs, etc.) in which the centers of sub-pixels form a triangle together.

According to the exemplary embodiment of the present invention, by making two of the three sub-pixels constituting a single pixel correspond to the same address electrodes, the number of address electrodes can be reduced. With such a structure, the increase in address power consumption in fabricating a high resolution panel can be restrained.

In addition, by converting the image signal data of the left and right pixels adjacent to the black or white vertical line into the magenta-biased or cyan-biased image signal data, the viability and readability of characters can be improved.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A method of driving a display device having a plurality of pixels, each pixel having three sub-pixels, the three sub-pixels each having centers defining a triangle together, and one side of the triangle being in the same direction as a vertical direction of a displayed image, the method comprising:
converting image signal data of a first pixel, the first pixel being a left pixel adjacent to a black or white vertical line to be displayed, into cyan-biased or magenta-biased image signal data upon the black or white vertical line having at least one pixel being displayed; and
converting image signal data of a second pixel, the second pixel being a right pixel adjacent to the black or white vertical line to be displayed, into cyan-biased or magenta-biased image signal data upon the black or white vertical line being displayed; and
driving the display device with the converted image signal data.

2. The method of claim 1, wherein the converting of the image signal data of the first pixel comprises converting the image signal data of the first pixel to alternately arrange the cyan-biased image signal data and the magenta-biased image signal data upon the first pixel referring to a plurality of pixels.

3. The method of claim 2, wherein the converting of the image signal data of the second pixel comprises converting the image signal data of the second pixel to alternately arrange the cyan-biased image signal data and the magenta-biased image signal data upon the second pixel referring to a plurality of pixels.

4. The method of claim 3, wherein a pixel among the second pixels positioned to be horizontal with respect to a certain pixel of the first pixels is converted into magenta-biased image signal data upon image signal data of the certain pixel among the first pixels being converted into cyan-biased image signal data.

5. The method of claim 1, further comprising converting image signal data of the left pixel adjacent to the black or white horizontal line into magenta-biased image signal data and converting image signal data of the right pixel adjacent to the black or white horizontal line into cyan-biased image signal data upon the black or white horizontal line having at least one pixel and being perpendicular to the vertical direction being displayed.

6. The method of claim 1, wherein, for the cyan-biased image signal data, a variation amount of image signal data of a green sub-pixel is smaller than an average of a variation amount of the image signal data of red and blue sub-pixels in the original image signal data.

7. The method of claim 1, wherein, for the magenta-biased image signal data, a variation amount of image signal data of a green sub-pixel is greater than an average of a variation amount of an image signal data of red and blue sub-pixels in the original image signal data.

8. The method of claim 1, wherein converting of the image signal data of the first pixel comprises converting the image signal data of the first pixel by reflecting image signal data of adjacent left and right pixels of the first pixel on the image signal data of the first pixel, and
wherein converting of the image signal data of the second pixel comprises converting the image signal data of the second pixel by reflecting image signal data of adjacent left and right pixels of the second pixel on the image signal data of the second pixel.

9. The method of claim 8, wherein the original image signal data is displayed at a pixel corresponding to the black or white vertical line.

10. The method of claim 1, further comprising:
arranging a plurality of row electrodes and a plurality of column electrodes defining each sub-pixel in the display device:
wherein two of the three sub-pixels correspond to the same column electrode, and each pixel corresponds to a 3/2 number of row electrodes.

11. The method of claim 10, wherein one of the two column electrodes disposed at the three sub-pixels is arranged to pass through two sub-pixels adjacent in the column direction, and the other column electrode is arranged to pass through the remaining sub-pixel.

12. The method of claim 10, wherein when the plurality of pixels are arranged in the form of n×n, the number of column electrodes and the number of row electrodes have a ratio of 4:3, wherein “n” is a natural number indicating the number of pixels successively arranged in the row direction or column direction.

13. The method of claim 1, wherein the black vertical line is a vertical line comprising pixels darker than adjacent pixels, and the white vertical line is a vertical line comprising pixels brighter than adjacent pixels.

14. A method of driving a display device having a plurality of pixels, each having three sub-pixels, centers of the three sub-pixels defining a triangle together, and one side of the triangle being in the same direction as a vertical direction of a displayed image, the method comprising:
converting image signal data of each pixel by reflecting image signal data of adjacent left and right pixels of each pixel;
calculating a first dispersion among sub-pixels of each pixel;
calculating a second dispersion among sub-pixels of each pixel using the converted image signal data; and
converting image signal data of a corresponding pixel into original image signal data upon the second dispersion being equal to or smaller than the first dispersion in the same pixel.

15. The method of claim 14, wherein the dispersion among the sub-pixels is calculated using the image signal data of the three sub-pixels.

16. The method of claim 14, wherein the image signal data of each pixel is converted by reflecting a ratio based on the same colors of sub-pixels of each pixel for the three sub-pixels of the adjacent left and right pixels.

17. The method of claim 14, wherein the left and right pixels adjacent to the black vertical line or the white vertical line are converted into the cyan-biased or magenta-biased image signal data by converting the image signals of each pixel upon the black or white vertical line having at least one pixel being displayed in the same direction as the vertical direction.

18. The method of claim 17, wherein image signal data of a pixel corresponding to the black or white vertical line is converted into the original image signal data by converting the original image signal data.

19. The method of claim 14, wherein the display device further comprises a plurality of row electrodes and a plurality of column electrodes defining each sub-pixel; wherein two of the three sub-pixels correspond to the same column electrode and wherein each pixel corresponds to a 3/2 number of row electrodes.

20. The method of claim 19, wherein one of the two column electrodes is arranged at the three sub-pixels to pass through the two sub-pixels adjacent in the column direction, and wherein the other column electrode is arranged to pass through the remaining sub-pixel.

21. A display device comprising:
a display panel having a plurality of row electrodes, a plurality of column electrodes arranged to cross the plurality of row electrodes, and a plurality of pixels defined by the plurality of row electrodes and the plurality of column electrodes, each pixel comprising three sub-pixels having centers defining a triangle together, one side of the triangle being oriented in a first direction in which the column electrodes extend;
a controller to generate a control signal for driving the plurality of row electrodes and the plurality of column electrodes from inputted image signal data; and
a driver to drive the plurality of row electrodes and the plurality of column electrodes according to the control signal;
wherein the controller converts image signal data of left and right pixels adjacent to a black vertical line into cyan-biased or magenta-biased image signal data upon the black vertical line having at least one pixel and being in the same direction as the first direction being displayed.

22. The device of claim 21, wherein the controller converts the image signal data of the left pixels to alternately arrange the cyan-biased image signal data and the magenta-biased image signal data at the left pixels adjacent to the black vertical line, and to convert the image signal data of the right pixels to alternately arrange the magenta-biased image signal data and the cyan-biased image signal data at the right pixel adjacent to the black vertical line.

23. The device of claim 21, wherein the controller converts the image signal data of the left and right pixels adjacent to the white vertical line into cyan-biased or magenta-biased image signal data upon a white vertical line having at least one pixel and being in the same direction as the first direction being displayed.

24. The device of claim 23, wherein the controller converts the image signal data of the left pixel to alternately arrange the magenta-biased image signal data and the cyan-biased image signal data at the left pixel adjacent to the white vertical line, and to convert the image signal data of the right pixel to alternately arrange the cyan-biased image signal data and the magenta-biased image signal data at the right pixel adjacent to the white vertical line.

25. The device of claim 21, wherein the controller converts image signal data of the left pixel adjacent to a black or white horizontal line into magenta-biased image signal data and image signal data of the right pixel adjacent to the black or white horizontal line into cyan-biased image signal data upon the black or white horizontal line comprising at least one pixel and being perpendicular to the first direction being displayed.

26. The device of claim 21, wherein a variation amount of image signal data of a green sub-pixel is smaller than an average of a variation amount of an image signal data of red and blue sub-pixels in the original image signal data for the cyan-biased image signal data, and wherein a variation amount of image signal data of the green sub-pixel is greater than an average of the variation amount of the image signal data of the red and blue sub-pixels in the original image signal data for the magenta-biased image signal data.

27. The device of claim 21, wherein the controller comprises:
a rendering processor to convert image signal data of each pixel by reflecting image signal data of the adjacent left and right pixels of each pixel; and
a feedback processor to calculate a first dispersion among three sub-pixels of each pixel using the inputted image signal data, to calculate a second dispersion among sub-pixels of each pixel using the image signal data converted by the rendering processor, and to re-convert the image signal data converted by the rendering processor into the original image signal data if the second dispersion is equal to or smaller than the first dispersion in the same pixel.

28. The device of claim 27, wherein the feedback processor re-converts image signal data of a pixel corresponding to the black or white vertical line into the original image signal data.

29. The device of claim 21, wherein the black vertical line comprises pixels darker than adjacent pixels.

30. The device of claim 23, wherein the white vertical line comprises pixels brighter than adjacent pixels.

31. The device of claim 21, wherein two of the three sub-pixels correspond to the same column electrode, and each pixel corresponds to the 3/2 number of row electrodes.

32. The device of claim 31, wherein one of the two column electrodes is arranged at the three sub-pixels to pass through two sub-pixels adjacent in the column direction, and the other column electrode is arranged to pass through the remaining sub-pixel.

33. The device of claim 31, wherein when the plurality of pixels are arranged in the form of n×n, the number of column electrodes and the number of row electrodes have the ratio of 4:3, wherein “n” is a natural number indicating the number of pixels successively arranged in the row direction or column direction.

34. The device of claim 31, wherein each sub-pixel has a hexagonal planar shape.

35. The device of claim 31, wherein each sub-pixel has a rectangular planar shape.
